(19) United States
(12) Patent Application Publication
(10) Pub. No.: US 2017/0027369 A1
(43) Pub. Date: Feb. 2, 2017

(54) Caffeine infused filters as a means of enhancing the concentration of caffeine delivered to beverages

(71) Applicant: Brian Patrick Zimmerman, 23 Wisteria Place, CA (US)

(72) Inventor: Brian Patrick Zimmerman, 23 Wisteria Place, CA (US)

(21) Appl. No.: 14/815,237

(22) Filed: Jul. 31, 2015

(51) Int. Cl. A47J 31/08

(52) U.S. Cl. CPC A47J 31/08

(57) ABSTRACT

A saturated aqueous solution of caffeine extract (organic/synthetic) is applied to the filtering apparatus (paper coffee/espresso filter, Keurig cup filter, tea bag, or perforated mesh filter of the like) to achieve the desired and appropriate* level of caffeine infusion upon the preferred filtering device. The filtering mechanism is subsequently dried, packaged, and distributed as a means of providing a safe and controlled level of caffeine delivery to such beverages as coffee, tea, or caffeinated beverages of the like. The caffeine infused filter serves to transfer the water soluble caffeine additive to the consumer's preferred beverage by way of the desired preparation method (decoction, gravitational feed, pressurized percolation, drip, steeping, or methodology of the like).

*Appropriate, as described above, refers to a recommended dosage of infused caffeine product as suggested by the manufacturer of the caffeine supplement. In addition, the concentration of caffeine obtained from the coffee seed, tea, herbal substance, or caffeinated material of the like is considered to achieve a safe, controlled, and desirable concentration of caffeine transfer to the preferred beverage.

### BRIEF DESCRIPTION OF DRAWINGS

FIG. 1 depicts an apparatus spraying an aqueous caffeine solution onto several filtering devices, thereby impregnating the porous and absorbent filter medium with variable caffeine concentrations.

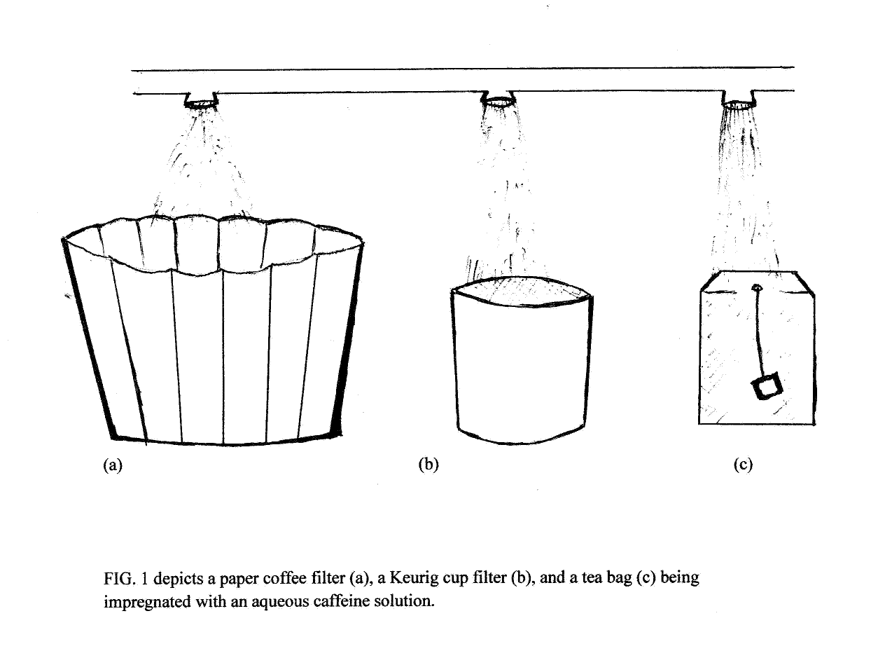

### DETAILED DESCRIPTION

It goes without saying that the consumption of caffeinated beverages, specifically coffee, has become a staple to the commencement of our day throughout the United States—and the world for that matter. According to the Huffington Post, Americans consume roughly 400 million cups of coffee each day, equivalent to 146 billion cups of coffee being consumed each year—making coffee one of the more prominent and iconic beverages of American culture. Unfortunately, often a less than satisfactory cup of coffee is encountered. At times, the inferiority is generated as a consequence of a minimal concentration of 1,3,7-Trimethylpurine-2,6-dione (caffeine) being imparted to the prepared beverage—either by way of subordinate preparation method, or an inherently weaker coffee seed, both resulting in a beverage which lacks the effectiveness and desirable qualities which the consumer has come to expect.

It is for this reason that I propose a safe and effective means of caffeinated beverage production—a revolutionary methodology whereby lacking caffeine concentration is a hindrance to quality no more. I have never seen, heard of, or been successful in discovering a process similar in nature to the heretofore suggested invention. Being the case that the processes described herein relate to an improvement upon, and enhancement of, existing filtering mechanisms, the unification of a perforated mesh filter with a purified caffeine extract can be seen as a novel junction and hence a unique invention.

A saturated aqueous solution of caffeine extract (organic/synthetic) is prepared via the dissolution of the purified anhydrous caffeine substance into water (solubility range of caffeine in water: 2.17 g/100 mL (25 ° C.), 18.0 g/100 mL (80° C.), 67.0 g/100 mL (100° C.)) (retrieved on 23 Jul. 2015 from https://en.wikipedia.org/wiki/Caffeine). Experimentation revealed that approximately 2 grams of anhydrous caffeine extract would saturate a volume of 100 mL of water at room temperature. Upon attainment of an aqueous caffeine solution, a spray-on, drip, or soaking method is utilized to impart a safe and desirable quantity of the saturated solution upon the filtering apparatus (paper coffee/espresso filter, Keurig cup filter, tea bag, or perforated mesh filter of the like). Infusion of the caffeine solution upon the filtering apparatus shall be in compliance with the recommended dosage as described by the manufacturer of the caffeine supplement. In general, a cumulative diffusive transfer of caffeine from the infused filter and caffeine imparted via the process of extraction from the preferred beverage will not be in excess of 200 mg per serving—as this caffeine dosage is suggested by many of the manufactures that I have encountered during preliminary trials of my invention.

To determine the limits of absorption potential for various filtering devices (a standard size basket style coffee filter accommodating 8 to 12 cups of coffee, a Keurig cup filter, and a tea bag), the dry weights were determined, then each apparatus was submerged in an aqueous caffeine solution and subsequently reweighed. The basket style coffee filter was found to retain approximately 7.19 mL of solution, the Keurig cup filter approximately 1.54 mL of solution, and the tea bag roughly 1.78 mL of solution (assuming that mass in grams is proportional to volume in mL; though minor deviations from actual absorption values exist, as solution density is a function of temperature). Given the solubility of anhydrous caffeine extract at various temperatures, the impregnation of filtering devices with an aqueous caffeine solution is achieved with ease—even at the upper limits of infusion.

Upon infusion of the appropriate* and desired concentration of the caffeinated solution to the filtering apparatus, the filtering mechanism is subsequently dried, packaged, and distributed as a means of providing a safe and controlled level of caffeine delivery to such beverages as coffee, tea, or caffeinated beverages of the like. The caffeine infused filter serves to transfer the water soluble caffeine additive to the consumer's preferred beverage by way of the desired preparation method (decoction, gravitational feed, pressurized percolation, drip, steeping, or methodology of the like). Given the water soluble nature of purified caffeine, no hindrance to beverage transfer through the filtering apparatus will be experienced. Accordingly, functionality of the filtering apparatus to be used will not be jeopardized during percolation.

*Appropriate, as described above, refers to a recommended dosage of infused caffeine product as suggested by the manufacturer of the caffeine supplement. In addition, the concentration of caffeine obtained from the coffee seed, tea, herbal substance, or caffeinated material of the like is considered to achieve a safe, controlled, and desirable concentration of caffeine transfer to the preferred beverage.

The methodologies described above serve to provide a safe, efficient, and effective enhancement to the caffeine concentration extracted by conventional means of processing/producing caffeinated beverages (decoction, gravitational feed, pressurized percolation, drip, steeping, or methodology of the like). The application of this invention serves to compliment the consumer's desired production method of their preferred caffeinated beverage; imparting not only an efficient and controlled method for caffeine delivery, but allows for the convenience of effectively enhancing the caffeinated beverage of choice while safeguarding from excessive caffeine consumption.

Additionally, variable graduations of caffeine infusions will be available for each filtration mechanism, allowing for consumers to explore and attain a concentration that is suitable.

### BRIEF SUMMARY

An aqueous solution of caffeine extract (organic/synthetic) is prepared via the dissolution of the purified caffeine substance into water. With a water solubility of 18.7 g/L at 16° C. (Sigma-Aldrich.com), an aqueous caffeine solution prepared from purified anhydrous caffeine powder (synthetic/organic) is easily attained. Upon preparation of the aqueous caffeine solution, a spray-on, drip, or soaking method is utilized to impart a safe and desirable quantity of the caffeine solution upon the filtering apparatus (paper coffee/espresso filter, Keurig cup filter, tea bag, or perforated mesh filter of the like). Upon infusion of the appropriate* and desired concentration of the caffeinated solution to the filtering apparatus, the filtering mechanism is subsequently dried, packaged, and distributed as a means of providing a safe and controlled level of caffeine delivery to such beverages as coffee, tea, or caffeinated beverages of the like.

*Appropriate, as described above, refers to a recommended dosage of infused caffeine product as suggested by the manufacturer of the caffeine supplement. In addition, the concentration of caffeine obtained from the coffee seed, tea, herbal substance, or caffeinated material of the like is considered to achieve a safe, controlled, and desirable concentration of caffeine transfer to the preferred beverage.

The caffeine infused filter serves to transfer the water soluble caffeine additive to the consumer's preferred beverage by way of the desired preparation method (decoction, gravitational feed, pressurized percolation, drip, steeping, or methodology of the like). Given the water soluble nature of purified caffeine, no hindrance to beverage transfer through the filtering apparatus will be experienced. Accordingly, functionality of the filtering apparatus to be used will not be jeopardized during percolation.

1. The processes discussed herein serve to unite traditional caffeinated beverage production methodologies (decoction, gravitational feed, pressurized percolation, drip, steeping, or methodology of the like) with an enhanced mode of caffeine delivery to prepared beverages via the infusion of variable concentrations of purified caffeine upon the filtering apparatus (paper coffee/espresso filter, Keurig cup filter, tea bag, or perforated mesh filter of the like) utilized in the production of the desired beverage.

2. The application of this invention serves to compliment the consumer's desired production method of their preferred caffeinated beverage; imparting not only an efficient and controlled method for caffeine delivery, but allows for the convenience of effectively enhancing the caffeinated beverage of choice while safeguarding from excessive caffeine consumption.

3. Additionally, variable graduations of caffeine infusions will be available for each filtration mechanism (paper coffee/espresso filter, Keurig cup filter, tea bag, or perforated mesh filter of the like), allowing for consumers to explore and attain a suitable caffeine concentration to be extracted from the filtration mechanism.
